(19) United States
(12) Patent Application Publication
(10) Pub. No.: US 2007/0172411 A1
(43) Pub. Date: Jul. 26, 2007

(54) Method of removing residual solvent from fullerene

(76) Inventors: Kenji Matsubayashi, Tokyo (JP); Ken Kokubo, Osaka (JP); Hiroya Takada, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 11/579,000

(22) PCT Filed: Apr. 18, 2005
(86) PCT No.: PCT/JP05/07742

§ 371 Date: Dec. 13, 2006

(30) Foreign Application Priority Data
Apr. 19, 2004 (JP) 2004-123370

(51) Int. Cl. C01B 31/02

(52) U.S. Cl. 423/461; 977/845

(57) ABSTRACT

A fullerene in which a solvent remains is subjected to heat treatment at a temperature higher than the boiling point of the solvent by 150° C. or more under a reduced pressure of 50 Torr or lower to reduce the residual amount of the solvent, and in order to allow the fullerene to be applied to drug products, the biohazardous residual solvent is reduced by a convenient method and removed until its concentration becomes equal to or lower than the regulatory limit.

### TECHNICAL FIELD

The invention of this application relates to a method of removing a residual solvent from a fullerene which draws attention as a compound having a bioactivity such as an antioxidative activity, an anticancer activity or an antimicrobial activity.

### BACKGROUND ART

C60, C70 fullerenes and fullerenes with a higher carbon spherical shell structure or tubular structure including chemically modified compounds or complexes thereof, clathrates and the like have been drawing attention as a compound having a bioactivity such as an antioxidative activity, an anticancer activity or an antimicrobial activity.

However, when such a fullerene is actually going to be used, it is not always easy to allow its excellent property such as the above-mentioned bioactivity to be expressed and to make such a property practically usable. For example, it is difficult to solubilize a fullerene and also to solubilize it in water.

In such a circumstance, the inventors of this application have already proposed a novel antioxidant or composition for external use containing a fullerene, a cosmetic material containing the same and the like (e.g., Patent Document 1), and specifically have proposed a water-soluble fullerene and an aqueous solution of a fullerene. In particular, from the viewpoint of both the manifestation and stability of the bioactivity, we have proposed a complex of a fullerene or a fullerene mixture with polyvinylpyrrolidone (PVP) as a compound to draw attention.

Although such a new development has been undertaken, as for the practical use of a fullerene, in particular when it is used in a drug product, a cosmetic product or the like by utilizing its bioactivity, a problem that an organic solvent to be used as an extraction solvent or the like in production or handling of the fullerene remains should be kept in mind. In fact, toluene, xylene, chlorobenzene or the like is used as an extraction solvent in conventional production of a fullerene by an arc-discharge method and subsequent operation, however, contamination of such an organic solvent into a drug product is strictly regulated as a biohazardous solvent. For example, according to the current “Guideline for Residual Solvents” (Pharmaceutical and Medical Safety Bureau: March 1998), with regard to Class 2 solvents which are the solvents whose residual amounts in drug products are regulated, their concentration limits (ppm) are clearly specified as follows: toluene (890 ppm), xylene (2170 ppm), chlorobenzene (360 ppm), dichloromethane (600 ppm), hexane (290 ppm), acetonitrile (410 ppm), etc.

However, as for a solvent which is known as a solvent for a fullerene, even if it is, for example, toluene, it was difficult to reduce the residual amount to the above-mentioned regulatory concentration limit or lower so far.

It is assumed that this is because a residual solvent is rigidly attached to the fullerene due to the unique molecular structure of the fullerene.

Patent Document 1: JP-A-2004-250690

### DISCLOSURE OF THE INVENTION

Therefore, in view of the background as described above, an object of the invention of this application is to provide a novel method capable of significantly reducing a residual solvent as a biohazardous solvent by a convenient method and removing the residual solvent until its concentration becomes equal to or lower than the above-mentioned regulatory concentration limit for allowing the fullerene to be also applied to a drug product.

This application provides the following inventions to achieve the above-mentioned object.

(1) A method of removing a residual solvent from a fullerene characterized by subjecting the fullerene in which a solvent remains to heat treatment at a temperature higher than the boiling point of the solvent by 150° C. or more under a reduced pressure of 50 Torr or lower to reduce the residual amount of the solvent.

(2) The above-mentioned method of removing a residual solvent characterized in that the solvent is an aromatic hydrocarbon, an aliphatic hydrocarbon or a halogenated hydrocarbon.

(3) A method of removing a residual solvent from a fullerene characterized by subjecting the fullerene in which a solvent toluene remains to heat treatment at a temperature of 300° C. to 600° C. under a reduced pressure of 10 Torr or lower to reduce the residual amount of toluene to 890 ppm or less.

(4) The method of removing a residual solvent of the above-mentioned (3), characterized in that the heating is carried out for 20 hours or more.

(5) A method of removing a residual solvent from a fullerene, in any of the above-mentioned methods characterized in that, swelling treatment is performed by adding the same solvent as the residual solvent before the heat treatment.

### BEST MODE FOR CARRYING OUT THE INVENTION

The invention of this application has characteristics as described above, and, its embodiments will be described below.

A method of removing a residual solvent of the invention of this application is achieved firstly by a convenient method of heat treatment under a reduced pressure. In this case, as a fullerene, a fullerene produced by a variety of production methods or a mixture thereof is used as a target. For example, it may be C60 or C70 which has been known so far, a fullerene with a higher carbon spherical shell structure, a variety of fullerenes with a tubular structure such as a carbon nanotube and a fullerene tube or a mixture thereof.

In addition, it may be a fullerene substituted with any of a variety of substituents as long as it is suitable for the object of the invention of this application.

Among these fullerens, one in which a solvent for extraction or the like remains, more specifically, one in which a biohazardous solvent remains at a concentration equal to or greater than the regulatory concentration limit (ppm) as described above is a main target of the invention of this application.

The type of the residual solvent may be various, and typical examples include aromatic hydrocarbons such as toluene and xylene, aliphatic hydrocarbons such as hexane, halogenated hydrocarbons such as chlorobenzene and dichloromethane and the like.

In the method of the invention of this application, the removal of the residual solvent is carried out by heat treatment at a temperature higher than the boiling point of the solvent by 150° C. or more under a reduced pressure of 50 Torr or lower, preferably 30 Torr or lower, more preferably 10 Torr or lower. It is necessary to set the temperature to a value within the range that does not cause thermal denaturation of the fullerene itself for the heat treatment. As a general standard, consideration is given so that the temperature is set to 600° C. or lower.

More specifically, describing the case of toluene as a most typical solvent for a fullerene, by subjecting a fullerene in which this solvent toluene remains to heat treatment at a temperature of 300° C. to 600° C. under a reduced pressure of 10 Torr or lower, the residual amount of toluene is reduced to the above-mentioned regulatory concentration limit of 890 ppm or less. In order to efficiently remove toluene while avoiding thermal denaturation of the fullerene, consideration is preferably given so that the heat treatment is carried out at a temperature of, for example around 350° C. (±20° C.) for 20 hours or more, more preferably about 24 hours or more.

Further, in the invention of this application, it is also effective to perform swelling treatment by adding a solvent that is the same as or similar to the residual solvent before the heat treatment.

Accordingly, hereinafter, more detail description will be made by showing Examples. Of course, the invention is not limited to the following examples.

### EXAMPLES

A fullerene mixture: MF (50 wt % or more of C60 fullerene, 10 wt % or more of C70 fullerene, and the remainder of higher fullerenes (commercially available products)) produced by an arc-discharge method using toluene (first grade, manufactured by Wako Pure Chemical Industries, Ltd.) as an extraction solvent was used.

The residual amount of the solvent toluene in this MF was 17200 ppm as described later.

### Example 1

5 g of the above-mentioned MF sample was ground (in an agate motar), put into a glass container and subjected to heat treatment in a vacuum heating device.

A 0.05 g portion of the heat-treated MF sample was dissolved by stirring in 200-fold amount of dichlorobenzene until solid matter was dissolved. Then, the residual amount of toluene in the sample was quantitatively analyzed by GC-MS.

In Table 1, the variation in the residual amount of toluene depending on the heating temperature is shown as the results of the case where heat treatment was carried out under a reduced pressure of 10 Torr for 24 hours.

In Table 2, the time course of the residual amount of toluene when heating was carried out at 350° C. under a reduced pressure of 10 Torr.

In Table 3, the variation in the residual amount of toluene depending on the degree of reduced pressure when heating was carried out at 350° C. for 24 hours.

TABLE 1
Variation in residual amount of solvent (toluene) in fullerene
with change in temperature
10 Torr
24 hours

| | Temperature (° C.) | | | | | |
|---|---|---|---|---|---|---|
| | 50 | 120 | 200 | 250 | 350 | 400 |
| Residual amount of | 17200 | 5338 | 3286 | 1993 | 330 | 296 |
| toluene (ppm) | | | | | | |

TABLE 2
Time course of residual amount of solvent (toluene) in fullerene
10 Torr
350° C.

| | Treating time (HR) | | | | | |
|---|---|---|---|---|---|---|
| | 0 | 6 | 12 | 24 | 48 | 72 |
| Residual amount of | 17200 | 5796 | 2150 | 302 | 286 | 262 |
| toluene (ppm) | | | | | | |

TABLE 3
Variation in residual amount of solvent (toluene) in fullerene
with change in degree of reduced pressure
24 hours
350° C.

| | Degree of reduced pressure (Torr) | | | | | |
|---|---|---|---|---|---|---|
| | 760 | 500 | 100 | 10 | 1 | 0.5 |
| Residual amount of | 8741 | 6629 | 1252 | 330 | 286 | 265 |
| toluene (ppm) | | | | | | |

As is also clear from Table 2, the residual amount of toluene before heat treatment is 17200.

From this Table 2, it is found that the amount of toluene can be reduced from the above-mentioned 17200 ppm to 302 ppm at a heating temperature of 350° C. for a treating time of 24 hours under a reduced pressure of 10 Torr.

In addition, from Tables 1, 2 and 3, it is found that the degree of reduced pressure to 50 Torr or lower, further the degree of reduced pressure to 10 Torr or lower, and heating at a temperature higher than the boiling point of toluene by 150° C. or more, further at 300° C. or more, particularly at around 350° C. or more are effective in significantly reducing the residual toluene.

### Example 2

To the MF sample whose residual amount of toluene was 17200 ppm, before the heat treatment under a reduced pressure of 10 Torr at 0° C. for 24 hours, as pretreatment, toluene was added in an amount equal to or greater than the MF sample and left for 1 hour to swell the MF sample. The residual amount of toluene in this case is shown. It is found that the residual amount of toluene is reduced to about one-tenth of that in the case where this pretreatment is not carried out.

TABLE 4
Pretreatment effect on residual amount of solvent (toluene) in
fullerene (swelling effect of toluene)
24 hours
350° C.
10 Torr

| | Without | With |
|---|---|---|
| Pretreatment (note: 1) | pretreatment | pretreatment |
| Residual amount of toluene (ppm) | 330 | 38 |

Note:
1 The sample was swollen by adding toluene in an amount equal to or greater than the sample and leaving it for 1 hour.

### INDUSTRIAL APPLICABILITY

According to the invention of this application as described above, in order to allow a fullerene to be applied to drug products, a residual solvent as a biohazardous solvent can be significantly reduced by a convenient method and can be removed until its concentration becomes equal to or lower than the above-mentioned regulatory concentration limit.

1. A method of removing a residual solvent from a fullerene characterized by subjecting the fullerene in which a solvent remains to heat treatment at a temperature higher than the boiling point of the solvent by 150° C. or more under a reduced pressure of 50 Torr or lower to reduce the residual amount of the solvent.

2. The method of removing a residual solvent according to claim 1, characterized in that the solvent is an aromatic hydrocarbon, an aliphatic hydrocarbon or a halogenated hydrocarbon.

3. A method of removing a residual solvent from a fullerene characterized by subjecting the fullerene in which a solvent toluene remains to heat treatment at a temperature of 300° C. to 600° C. under a reduced pressure of 10 Torr or lower to reduce the residual amount of toluene to 890 ppm or less.

4. The method of removing a residual solvent according to claim 3, characterized in that the heating is carried out for 20 hours or more.

5. A method of removing a residual solvent from a fullerene characterized in that, in the method according to claim 1, swelling treatment is performed by adding a solvent that is the same as or similar to the residual solvent before the heat treatment.

6. A method of removing a residual solvent from a fullerene characterized in that, in the method according to claim 2, swelling treatment is performed by adding a solvent that is the same as or similar to the residual solvent before the heat treatment.

7. A method of removing a residual solvent from a fullerene characterized in that, in the method according to claim 3, swelling treatment is performed by adding a solvent that is the same as or similar to the residual solvent before the heat treatment.

8. A method of removing a residual solvent from a fullerene characterized in that, in the method according to claim 4, swelling treatment is performed by adding a solvent that is the same as or similar to the residual solvent before the heat treatment.
